(19) United States
(12) Patent Application Publication
(10) Pub. No.: US 2026/0331101 A1
(43) Pub. Date: Oct. 22, 2026

(54) METHOD OF GENERATING SPEECH TOKENS CAPABLE OF BEING EASILY TRANSFORMED INTO TEXT TOKENS AND SPOKEN LANGUAGE MODEL SYSTEM USING THE SAME

(71) Applicant: ELECTRONICS AND TELECOMMUNICATIONS RESEARCH INSTITUTE, Daejeon (KR)

(72) Inventors: Dong Hyun Kim, Daejeon (KR); min kyu lee, Daejeon (KR); Yo han Lim, Daejeon (KR); Sanghun Kim, Daejeon (KR)

(21) Appl. No.: 19/361,489

(22) Filed: Oct. 17, 2025

(30) Foreign Application Priority Data
Mar. 20, 2025 (KR) 10-2025-0036032

(51) Int. Cl. G10L 15/16; G10L 15/06

(52) U.S. Cl. CPC G10L 15/16; G10L 15/063

(57) ABSTRACT

Disclosed are a method of generating speech tokens capable of being easily transformed into text tokens and a spoken language model system using the same. The method includes a training step of training an autoencoder, including an encoder configured to down-sample input speech data while transforming and compressing the input speech data into a vector, a vector quantizer configured to quantize data that have experienced the encoder into codebooks, and a decoder configured to reconstruct quantized codebook vectors as an original speech by combining the quantized codebook vectors, by using a speech recognizer that includes a speech recognizer encoder, a CTC module, and a speech recognizer decoder and that is trained by byte pair encoding (BPE) and a generation step of generating the output of the first codebook of the autoencoder that is trained as a speech token for a speech that is input to the autoencoder.

### CROSS-REFERENCE TO RELATED APPLICATION

The present application claims priority to and the benefit of korean patent application no. 10-2025-0036032, filed on Mar. 20, 2025, in the korean intellectual property office, the entire disclosure of which is incorporated herein by reference.

### BACKGROUND

### 1. Technical Field

The present disclosure relates to a method of generating speech tokens capable of being easily transformed into text tokens and a spoken language model system using the same.

### 2. Related Art

A speech chatbot system may be implemented with a speech recognizer, a text language model, and a speech synthesizer. However, since the three models are essentially trained separately and then combined, the process is executed in a sequential manner, and a response can only be generated after the completion of each step. Accordingly, such a construction inevitably results in a slow reaction time.

High-capacity language model-based systems use a method of generating a language model based on text tokens and associating an input speech with the text tokens by recognizing the input speech. For example, in the ChatGPT app, after a speech query that is received through a microphone is recognized by using an OpenAI Whisper model, a sentence that generated by transferring the speech query to ChatGPT is heard in the form of a synthesized sound. In such a method, it is difficult to make a response by generating a speech corresponding to speech styles, such as the speech speed and tone of a questioner, because information generated in the form of text tokens is played back by using a separate speech synthesizer. Furthermore, a generative spoken language model (GSLM) method is a method of clustering speech data by using a hidden-unit BERT (HuBERT) method, using the speech data as speech tokens corresponding to phoneme-level units, and generating a speech-based language model (LLM) through only a speech without text by using speech tokens divided as described above as vectors. However, the GSLM method also uses a speech transformation model, such as the existing WaveNet, when transforming generated vectors into a speech. That is, the speech is played back according to a preset speech synthesizer that is not affected by the speech style of a questioner.

Recently, attempts have been made to incorporate the speech style of a speaker when generating a synthesized sound by inputting the speech style into information. Furthermore, audio codec techniques in which a speech is quantized so that the speech can be transformed into several types of codebook information and codebooks are combined and played back as an original sound are attempted as speech tokens to be applied to a spoken language model. For example, in a technique called a speech tokenizer, HuBERT classification has been applied to a quantization codebook. The first codebook and the remaining codebooks are modeled so that the first codebook contains phonetic value information and the remaining codebooks contain speech rhyme and style information, and are used as speech tokens. Such a method produces an effect similar to using speech tokens based on codebooks classified at the phoneme level because a clustering of all of speeches is used as a quantization codebook. Accordingly, the method has limitations in distinguishing and representing large amounts of information, such as text, and also presents difficulties in integrating and modeling with a text-based language model.

### SUMMARY

Various embodiments are directed to generating a compressed speech token by which phonetic value information and rhyme information of a speaker can be well transferred.

Various embodiments are directed to easily transforming phonetic value information and rhyme information into a well-preserved synthetic speech when a speech token having speech information includes a speech token string.

Various embodiments are directed to generating a speech token capable of better containing and transferring context, such as text semantics information, as if a generative text language model may express a lot of text semantics information by using text tokens.

Various embodiments are directed to generating speech tokens which may be better combined with a generative text language model. This is for generating a generative spoken language model by using the ability to produce a speech of a generative text language model.

Various embodiments are directed to providing a method and system capable of processing all of processes as an end-to-end process so that a large amount of data can be used.

A method of generating speech tokens capable of being easily transformed into text tokens according to an embodiment of the present disclosure includes steps of training an autoencoder by using a speech recognizer that comprises a speech recognizer encoder, a CTC module, and a speech recognizer decoder and that is trained by byte pair encoding (BPE), the autoencoder comprising an encoder configured to down-sample input speech data while transforming and compressing the input speech data into a vector, a vector quantizer configured to quantize data that have experienced the encoder into a plurality of codebooks, and a decoder configured to reconstruct quantized codebook vectors as an original speech by combining the quantized codebook vectors, and generating an output of a first codebook of the autoencoder that is trained as a speech token for a speech that is input to the autoencoder.

In an embodiment, in the training step, a vector distance is used as a loss, the vector distance being calculated through steps of generating a first codebook vector of the input speech data through the vector quantizer of the autoencoder, performing a forward operation on the input speech data through the speech recognizer encoder, and performing a vector distance operation between a vector on which the execution of the forward operation has been finished and a first codebook vector.

In an embodiment, in the training step, a difference between a first probability distribution and a second distribution is used as a loss, the first probability distribution and the second distribution being calculated through steps of generating a first codebook vector of the input speech data through the vector quantizer of the autoencoder, calculating a vector that has experienced the speech recognizer encoder by performing a forward operation on the input speech data through the speech recognizer encoder, and measuring the first probability distribution of a vector that has experienced the speech recognizer encoder in speech recognizer CTC and the second probability distribution that has experienced the speech recognizer CTC as the first codebook vector.

In an embodiment, in the training step, a difference between a first probability distribution and a second probability distribution is used as a loss, the first probability distribution and the second distribution being calculated through steps of generating a first codebook vector of the input speech data through the vector quantizer of the autoencoder, calculating a vector that has experienced the speech recognizer encoder by performing a forward operation on the input speech data through the speech recognizer encoder, and measuring the first probability distribution of a vector that has experienced the speech recognizer encoder in the speech recognizer decoder and the second probability distribution that has experienced the speech recognizer decoder as the first codebook vector.

In an embodiment, the training step includes generating a codebook so that the codebook learns components of a style of the speech by performing a residual vector quantization operation except the first codebook vector, among encoder output vectors of the autoencoder.

In an embodiment, the training step may include steps of generating speech data by performing the forward operation on a sum vector of all of the codebooks through the decoder, measuring an adversarial loss of the generated speech data through a discriminator operation of determining a similar degree with respect to a time domain and a frequency domain with the input speech data, and performing inverse propagation on the plurality of measured losses through a differential operation and updating parameters of a model.

In an embodiment, the training step is repeated by a predetermined training number or until a predetermined threshold of each of the losses is reached.

A spoken language model system according to an embodiment of the present disclosure includes an autoencoder model including an encoder configured to down-sample input speech data while transforming and compressing the input speech data into a vector, a vector quantizer configured to quantize data that have experienced the encoder into a plurality of codebooks, and a decoder configured to reconstruct quantized codebook vectors as an original speech by combining the quantized codebook vectors, trained by using a speech recognizer that includes a speech recognizer encoder, a CTC module, and a speech recognizer decoder and that is trained by byte pair encoding (BPE), and configured to output the output of the first codebook as a query speech token of input query speech data and a speech language generation model including a speech-based language model configured to generate a speech token as a response to the query speech token and a style adder transformation model configured to generate a reconstructed speech token by using a vector string from at least some of the plurality of codebooks with respect to the generated speech token. The reconstructed speech token is output through the decoder of the autoencoder model.

The spoken language model system according to an embodiment of the present disclosure may further include a speech recognizer configured to transform the generated speech token into text.

In an embodiment, the autoencoder model may be trained by using a vector distance as a loss, the vector distance being calculated through steps of generating a first codebook vector of the input speech data through the vector quantizer of the autoencoder, performing a forward operation on the input speech data through the speech recognizer encoder, and performing a vector distance operation between a vector on which the execution of the forward operation has been finished and a first codebook vector.

In an embodiment, the autoencoder model may be trained by using a difference between a first probability distribution and a second probability distribution as a loss, the first probability distribution and the second distribution being calculated through steps of generating a first codebook vector of the input speech data through the vector quantizer of the autoencoder, calculating a vector that has experienced the speech recognizer encoder by performing a forward operation on the input speech data through the speech recognizer encoder, and measuring the first probability distribution of a vector that has experienced the speech recognizer encoder in speech recognizer CTC and the second probability distribution that has experienced the speech recognizer CTC as the first codebook vector.

In an embodiment, the autoencoder model may be trained by using a difference between a first probability distribution and a second probability distribution as a loss, the first probability distribution and the second distribution being calculated through steps of generating a first codebook vector of the input speech data through the vector quantizer of the autoencoder, calculating a vector that has experienced the speech recognizer encoder by performing a forward operation on the input speech data through the speech recognizer encoder, and measuring the first probability distribution of a vector that has experienced the speech recognizer encoder in the speech recognizer decoder and the second probability distribution that has experienced the speech recognizer decoder as the first codebook vector.

In an embodiment, the autoencoder model may be trained through steps of generating a codebook so that the autoencoder model learns components of a style of a speech by performing a residual vector quantization operation except the first codebook vector, among encoder output vectors of the autoencoder, generating the speech data by performing a forward operation on a sum vector of all of the codebooks through the decoder, measuring an adversarial loss of the generated speech data through a discriminator operation of determining a similar degree with respect to a time domain and a frequency domain with the input speech data, and performing inverse propagation on a plurality of measured losses through a differential operation and updating parameters of the autoencoder model.

A spoken language model system according to an embodiment of the present disclosure includes an autoencoder model comprising an encoder configured to down-sample input speech data while transforming and compressing the input speech data into a vector, a vector quantizer configured to quantize data that have experienced the encoder into a plurality of codebooks, and a decoder configured to reconstruct quantized codebook vectors as an original speech by combining the quantized codebook vectors, the autoencoder model being trained by using a speech recognizer that comprises a speech recognizer encoder, a CTC module, and a speech recognizer decoder and that is trained by byte pair encoding (BPE), and the autoencoder model being configured to output an output of a first codebook as a query speech token of input query speech data; a token transfer network configured to transform the query speech token into a text token by distilling the query speech token as embedding text; an adaptive-trained text model configured to generate a text token as a response to the text token; an inverse token transfer network configured to transform the generated text token into a generated speech token; and a style adder transformation model configured to generate a reconstructed speech token by using a vector string from at least some of the plurality of codebooks with respect to the generated speech token, wherein the reconstructed speech token is output through the decoder of the autoencoder model.

In an embodiment, the autoencoder model may be trained by using a vector distance as a loss, which is calculated through steps of generating a first codebook vector of the input speech data through the vector quantizer of the autoencoder, performing a forward operation on the input speech data through the speech recognizer encoder, and performing a vector distance operation between a vector on which the execution of the forward operation has been finished and a first codebook vector.

In an embodiment, the autoencoder model may be trained by using a difference between a first probability distribution and a second probability distribution as a loss, the first probability distribution and the second distribution being calculated through steps of generating a first codebook vector of the input speech data through the vector quantizer of the autoencoder, calculating a vector that has experienced the speech recognizer encoder by performing a forward operation on the input speech data through the speech recognizer encoder, and measuring the first probability distribution of a vector that has experienced the speech recognizer encoder in speech recognizer CTC and the second probability distribution that has experienced the speech recognizer CTC as the first codebook vector.

In an embodiment, the autoencoder model may be trained by using a difference between a first probability distribution and a second probability distribution as a loss, the first probability distribution and the second distribution being calculated through steps of generating a first codebook vector of the input speech data through the vector quantizer of the autoencoder, calculating a vector that has experienced the speech recognizer encoder by performing a forward operation on the input speech data through the speech recognizer encoder, and measuring the first probability distribution of a vector that has experienced the speech recognizer encoder in the speech recognizer decoder and the second probability distribution that has experienced the speech recognizer decoder as the first codebook vector.

In an embodiment, the autoencoder model may be trained through steps of generating a codebook so that the autoencoder model learns components of a style of a speech by performing a residual vector quantization operation except the first codebook vector, among encoder output vectors of the autoencoder, generating the speech data by performing a forward operation on a sum vector of all of the codebooks through the decoder, measuring an adversarial loss of the generated speech data through a discriminator operation of determining a similar degree with respect to a time domain and a frequency domain with the input speech data, and performing inverse propagation on a plurality of measured losses through a differential operation and updating parameters of the autoencoder model.

In an embodiment, the adaptive-trained text model may be obtained by training a text-based language model by using an additional parameter according to a low rank adaptation (LoRA) method.

In an embodiment, the token transfer network transforms the speech token into a text token according to a consecutive pattern based on a probability. The inverse token transfer network outputs the speech token that is closest to an input text token in probability. The speech token may generate the token transfer network by distilling a distance between the embedding text vector and the vector, that is, an answer transcript, in a way to reduce the distance.

According to an embodiment of the present disclosure, a combination between models is facilitated because speech tokens are generated by a text-based BPE algorithm for text tokens and thus lots of tokens having the same semantics are generated. This enables a generative speech language model to be generated by using power of expression of the existing large generative language model.

According to an embodiment of the present disclosure, the encoder of the speech codec has learned the inference ability of the speech recognizer. Accordingly, it is possible to generate a domain-specific generative spoken language model if a lot of speech data not including transcript having a specific domain is collected and used for training.

According to an embodiment of the present disclosure, speech tokens are easily transformed into text tokens. Accordingly, convenience of an interface can be improved because information can be exchanged in the form of a speech and can also be expressed in the form of text when communicating with a person through a speech chatbot.

According to an embodiment of the present disclosure, the improvement of performance using more data can be expected in a generative spoken language model because speech tokens are generated through an end-to-end process using lost of speech data.

Effects of the present disclosure which may be obtained in the present disclosure are not limited to the aforementioned effects, and other effects not described above may be evidently understood by a person having ordinary knowledge in the art to which the present disclosure pertains from the following description.

### BRIEF DESCRIPTION OF THE DRAWINGS

FIG. 1 is a construction diagram illustrating a construction of a speech language model (LLM) system using speech tokens.

FIG. 2 is a flowchart illustrating a training process of generating speech tokens by applying a speech recognizer in an embodiment of the present disclosure.

FIG. 3 is a block diagram for describing an autoencoder training method to which a speech recognizer encoder has been applied in an embodiment of the present disclosure.

FIG. 4 is a block diagram for describing an autoencoder training method to which a speech recognizer CTC module has been applied in an embodiment of the present disclosure.

FIG. 5 is a block diagram for describing an autoencoder training method to which a speech recognizer decoder has been applied in an embodiment of the present disclosure.

FIG. 6 is a block diagram illustrating a construction of a speech LLM system using a speech token model to which a speech recognizer has been applied according to an embodiment of the present disclosure.

FIG. 7 is a diagram in which paths along which a speech query is processed are indicated in the speech LLM system of FIG. 6.

FIG. 8 is a block diagram illustrating a construction of a speech LLM system in which a speech token model to which the speech recognizer has been applied has been adapted and trained for the existing text model in an embodiment of the present disclosure.

FIG. 9 is a diagram in which paths along which a speech query is processed are indicated in the speech LLM system of FIG. 8.

### DETAILED DESCRIPTION

The aforementioned object, other objects, advantages, and characteristics of the present disclosure and a method for achieving the objects, advantages, and characteristics will become clear with reference to embodiments to be described in detail along with the accompanying drawings.

However, the present disclosure is not limited to embodiments disclosed hereinafter, but may be implemented in various different forms. The following embodiments are merely provided to easily notify a person having ordinary knowledge in the art to which the present disclosure pertains of the objects, constructions, and effects of the present disclosure. The scope of rights of the present disclosure is defined by the writing of the claims.

Terms used in this specification are used to describe embodiments and are not intended to limit the present disclosure. In this specification, an expression of the singular number includes an expression of the plural number unless clearly defined otherwise in the context. The term “comprises” and/or “comprising” used in this specification does not exclude the presence or addition of one or more other components, steps, operations and/or components in addition to mentioned components, steps, operations and/or components.

### 1. Generative Speech Language System Using Speech Tokens

In general, a generative speech language system capable of question and answer using a speech includes a part that is responsible for an input and output through which a speech is transformed into text and the text is transformed into the speech and a text language model that forms a sentence based on context suitable for a question. However, the generative speech language system has problems in that the reaction speed is slow and more semantics of a speech are missing in a process of transforming the speech into text because processes, such as speech recognition, speech synthesis, and text generation, need to be performed.

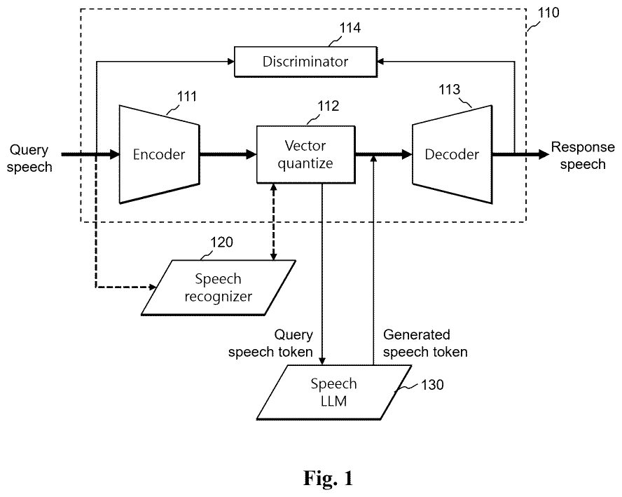

In order to solve such problems, there are attempts in which the part that is responsible for the input and output of a speech is used as one model. In FIGS. 1, 110 indicates the structure of such an autoencoder. The autoencoder generates a speech again through a deep learning network with respect to an input speech, and representatively includes an encodec model. An encoder 111 transforms input speech data into vectors and down-samples the speech data while compressing the speech data. A vector quantizer 112 quantizes the data that have been experienced the encoder 111 into codebooks. Although a case in which eight codebooks are used has been illustrated in the drawing, but the present disclosure is not limited thereto. As several codebooks are used, the codebooks may be quantized as various components. A decoder 113 reconstructs the quantized codebook vectors into an original speech by combining the quantized codebook vectors. That is, the autoencoder 110 compresses the input speech by the encoder 111 by applying the principle of the speech codec that compresses and plays back a speech and down-samples the input speech so that the vector quantizer 112 transfers information in the form of compressed codebook vectors instead of a basic speech and a speech having original sound quality is obtained through the decoder 113.

If such a model is to be trained, a discriminator 114 that determines a data difference according to a time domain or frequency domain between an input speech and a playback speech also needs to be constructed. An advantage of such a model is that a speech can be played back again by handling a small amount of compressed codebook vectors compared to the speech.

As a text language model constructs a text token model in a byte pair encoding (BPE) unit in which a lot of text is reconstructed by being split by frequency, there are attempts to apply a codebook through attempts to produce speech tokens by splitting speeches in a predetermined speech unit. In particular, if a residual vector quantizer scheme is applied to the output value of the encoder, a lot of information corresponding to the semantics of a sound remains in the first codebook, and speech style information, such as rhymes and tones, remain toward the remaining codebooks.

In a conventional speech tokenizer method, a model was trained to incorporate the output of the model that has been clustered by hidden-unit BERT (HuBERT) into the first codebook so that only semantics information of a sound remains in the first codebook. In general, this is called that the first codebook is distilled by using HuBERT. Furthermore, attempts have been made to combine such a method with a language model by using such distillation as a speech token. In such a method, it is considered that the method can be well combined with a language model only when speech tokens are generated based on semantics information of a sound in a speech.

In order to perform training in a multi-modal way by projecting text and embedding vectors of a speech onto a vector space, association in the vector space needs to be trained by using more data.

Embodiments of the present disclosure propose speech tokens that are used in the training of a speech-based language model (LLM) 130. In order to generate the speech tokens, the vector quantizer 112 including a text byte pair encoding (BPE) algorithm is trained so that the first codebook of the vector quantizer 112 becomes the same as the BPE unit like a byte pair encoding (BPE) model in which text tokens are used. This may also be called that the first codebook is distilled by using the speech recognizer 120. To this end, the codewords of the first codebook may be used by increasing the number of codewords by the number of BPEs. The speech LLM 130 may be trained by using the quantized codebook vectors of the vector quantizer 112 trained as described above as speech tokens.

There is a limitation in transferring various types of context based on only semantics information of a sound of a conventional speech tokenizer. In an embodiment of the present disclosure, long context can be better processed like text BPE by performing training so that the first codebook becomes the BPE unit. Furthermore, an easier approach is possible even with a combination with a text language model having a large amount of information. The reason for this is that if the first codebook generated in the BPE unit is used as a speech token, the first codebook can be easily transformed into text BPE by the connectionist temporal classification (CTC) of the speech recognizer or the decoder.

2. Training Using Speech Tokens Capable of Being Easily Transformed into Text Tokens

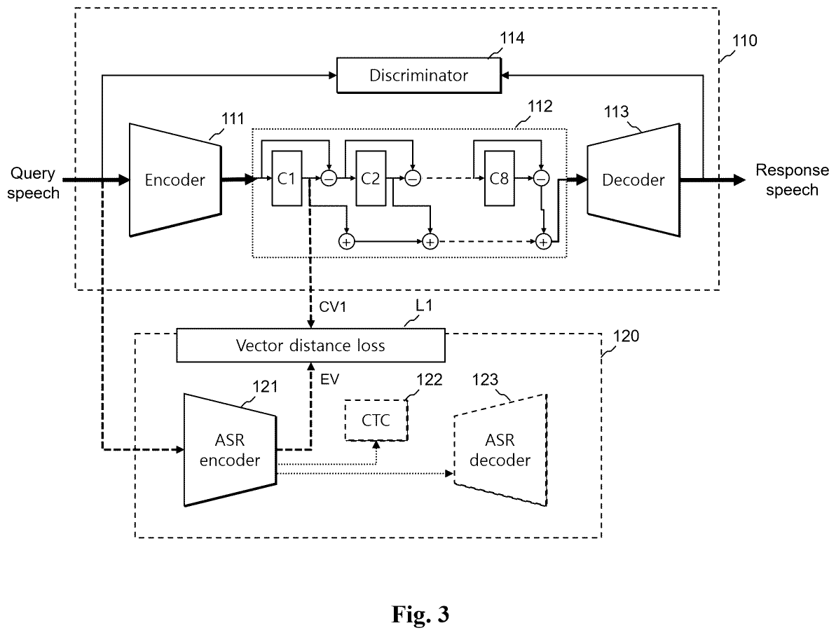

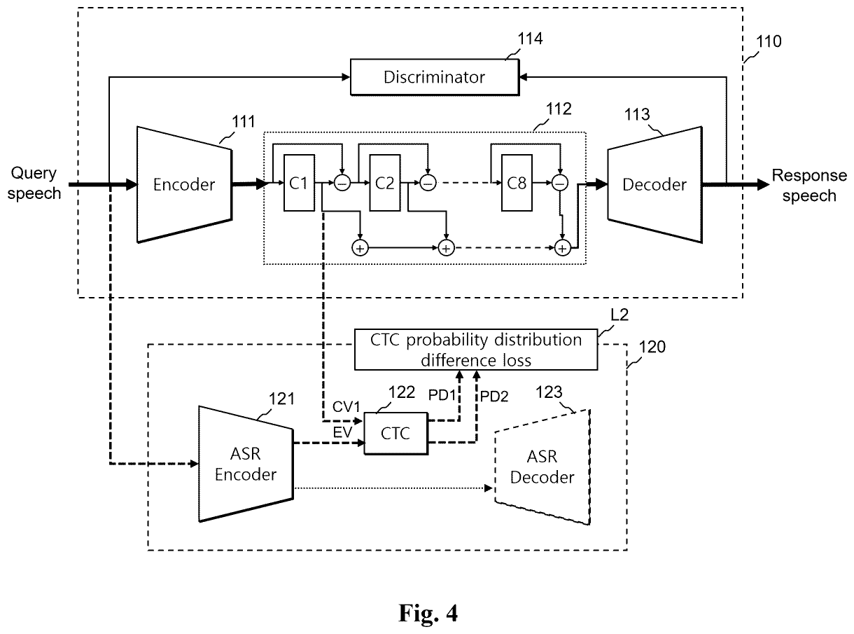

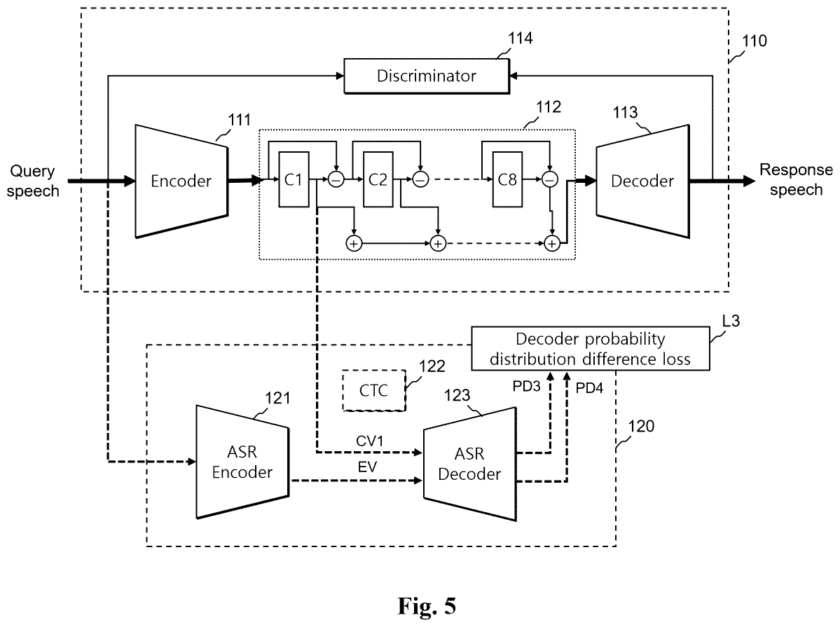

In an embodiment of the present disclosure, in order to generate speech tokens, a speech recognizer that outputs BPE tokens that are previously generated by a byte pair encoding (BPE) algorithm is used. FIGS. 3 to 5 illustrate three methods for applying the BPE discrimination ability of the speech recognizer 120 to a speech codec (autoencoder) model. In FIG. 3, an autoencoder model is trained by using an automatic speech recognition (ASR) encoder (hereinafter referred to as a “speech recognizer encoder”) 121 of the speech recognizer 120. In FIG. 4, an autoencoder model is trained by using the speech recognizer encoder 121 and CTC module 122 of the speech recognizer 120. In FIG. 5, an autoencoder model is trained by using the speech recognizer encoder 121 and ASR decoder (hereinafter referred to as a “speech recognizer decoder”) 123 of the speech recognizer 120.

FIG. 3 illustrates a method of applying the output of the speech recognizer encoder 121 of the speech recognizer 120 to the first codebook C1 that has experienced the encoder 111 of the speechcodec 110, and is a method of training the autoencoder 110 in order to become similar to the probability distribution output of the speech recognizer encoder 121 of the speech recognizer 120. The residual vector quantizer 112 quantizes residual vectors based on the output value of the encoder 111, and learns the first codebook C1 having a representative component, among them. The speech recognizer 120 is pre-trained by text BPE. The speech recognizer encoder 121 generates compressed vectors of an input speech. In an embodiment, the speech recognizer 120 may be a speech recognizer including only an encoder and CTC in order to maximize the ability of the encoder 111. Furthermore, the output vector of the speech recognizer encoder 121 may be an output vector that is obtained by summing and averaging the outputs of layers of the speech recognizer encoder. In the method of FIG. 3, a distance L1 of a codebook vector CV1 indicated by the first codebook and an output vector EV of the speech recognizer encoder 121 is used as a loss that is used for the training of the autoencoder model.

FIG. 4 illustrates a method of applying the output of a CTC module 122 through the speech recognizer encoder 121 of the speech recognizer 120 to the first codebook C1 that has experienced the encoder 111 of the autoencoder 110. The method is a method of training the autoencoder 110 in order to become similar to the probability distribution output of the CTC module 122 that is clustered for a BPE output through the speech recognizer encoder 121 of the speech recognizer 120. Even in this case, the speech recognizer 120 may be a speech recognizer including only an encoder and CTC in order to maximize the ability of the encoder. Furthermore, the output vector of the speech recognizer encoder may be an output vector that is obtained by summing and averaging the outputs of layers of the encoder.

The residual vector quantizer 112 quantizes the residual vectors based on the output value of the encoder 111, and learns the first codebook C1 having a representative component, among them. The speech recognizer 120 is pre-trained by text BPE. The speech recognizer encoder 121 generates compressed vectors of an input speech. The CTC module 122 of the speech recognizer 120 calculates a probability distribution of the text BPE. In the method of FIG. 4, a difference L2 between a CTC probability distribution of vectors received from the speech recognizer encoder 121 and a CTC probability distribution calculated as a codebook vector input is incorporated as a loss.

FIG. 5 is a method of applying the output of the speech recognizer decoder 123 of the speech recognizer 120 to the first codebook C1 that has experienced the encoder 111 of the autoencoder 110. This is a method of training the encoder 111 of the autoencoder 110 in order to become similar to a final probability distribution for a BPE output that is generated by the speech recognizer decoder 123 of the speech recognizer 120.

The residual vector quantizer 112 quantizes residual vectors based on the output value of the encoder 111, and learns the first codebook C1 having a representative component, among them. The speech recognizer 120 is pre-trained by text BPE. The speech recognizer encoder 121 generates compressed vectors of an input speech. The speech recognizer decoder 123 calculates a probability distribution of text BPE into which context has been incorporated. In the method of FIG. 5, a difference L3 between a decoder probability distribution of vectors received from the speech recognizer encoder 121 and a decoder probability distribution calculated as a codebook vector input is incorporated as a loss.

The three methods may be individually used depending on desired characteristics because the three methods include different speech recognizer processing steps and are different in detailed characteristics. Two or more of the three methods may be used for mutual supplementation.

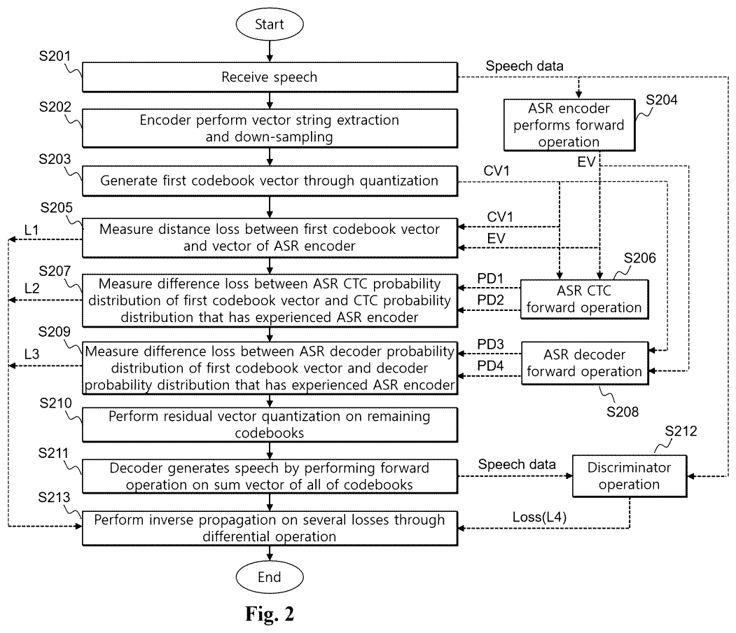

FIG. 2 is a flowchart illustrating a process of training the autoencoder 110 for generating speech tokens by using the three methods together.

The encoder 111 receives speech data (step S201) and performs vector string extraction and down-sampling on the speech data (step S202). The vector quantizer 112 generates the first codebook vector CV1 by quantizing the down-sampled data (step S203). Furthermore, the speech recognizer encoder 121 performs a forward operation on the input speech data (step S204).

The speech recognizer 120 measures a vector distance loss L1 so that A vector EV on which the execution of the forward operation has been finished and the first codebook vector CV1 becomes close to each other by performing a vector distance operation on the vector EV and the first codebook vector CV1 (step S205). As may be seen from FIG. 3, the first codebook CV1 of the residual vector quantizer 112 is a vector that contains the largest amount of information, and the speech recognizer encoder 121 is a model trained in the BPE unit. Accordingly, training the speech recognizer 120 to reduce the loss between the two vectors CV1 and EV results in generating the first codebook C1 in terms of BPE units.

The first codebook vector CV1 that is generated in step S203 and the vector EV that is generated in step S204 are input to the speech recognizer CTC 122. The speech recognizer CTC 122 measures a probability distribution value PD2 of the vector that has experienced the speech recognizer encoder 121 and a probability distribution value PD1 that has experienced the speech recognizer CTC 122 as the first codebook vector (step S206). The speech recognizer CTC 122 generates a CTC probability distribution difference loss L2 by measuring a difference between the two measured probability distributions (207). This process corresponds to a process of the speech recognizer CTC 122 calculating the probability distribution of the vectors based on the first codebook vector CV1 of the residual vector quantizer 112 and the vector EV that has experienced the speech recognizer encoder 121 in FIG. 4 and calculating the loss L2 for the difference between the calculated probability distributions. In this case, the CTC output distribution modeled in the BPE unit is trained to become similar to that in the first codebook C1.

The speech recognizer decoder 123 performs a forward operation on the codebook vector CV1 generated in step S203 and the vector EV generated in step S204, and calculates a probability distribution value PD4 of the vector that has experienced the speech recognizer encoder 121 and a probability distribution value PD3 that has experienced the speech recognizer decoder 123 as the first codebook vector (step S208). A difference between the two calculated probability distribution values is measured as a decoder probability distribution difference loss L3 (step S209). This process corresponds to the process of operating the probability distribution by inputting the first codebook vector CV1 of the residual vector quantizer 112 to the speech recognizer decoder 123, calculating the probability distribution by inputting the output of the speech recognizer encoder 121 to the speech recognizer decoder 123, then measuring a difference between the probability distributions as the decoder probability distribution difference loss L3, and training the residual vector quantizer 112 by the first codebook C1 so that the difference becomes similar to the output of the decoder of the speech recognizer that is trained in the BPE unit in FIG. 5.

Next, a codebook is generated so that components of several styles, such as the rhyme, gender, tones, and pitch of a speech, are learnt by performing a residual vector quantization operation on the remaining codebooks C2 to C8 (step S210). This step is a step of generating a quantization codebook again based on elements except the first codebook vector in the encoder output vector of the autoencoder. Accordingly, the components of the speech style, such as a speech rhyme, are modeled. The decoder 113 generates speech data by performing a forward operation on a sum vector of all of the codebooks (step S211). An adversarial loss L4 of the speech data that have been generated as described above is measured (step S212) through a discriminator operation of discriminating a similar degree with respect to a time domain and a frequency domain with the speech data input in step S201. An inverse propagation is performed on the several losses L1, L2, L3, and L4 calculated as described above through a differential operation, and the parameter of the model is updated (step S213).

The operation of FIG. 2 is repeated by a predetermined training number or until a predetermined threshold of each of the losses is reached. When an autoencoder model is generated as described above, speech styles, such as rhymes, a pitch, and speaker characteristics, almost disappear from the first codebook C1, and only the semantics of the sound remain. Accordingly, when the results are played back as a speech, a sound that transfers context based on a phonetic value is heard as a mechanical speech.

3. System that Performs Both Speech Generation and Text Transcript

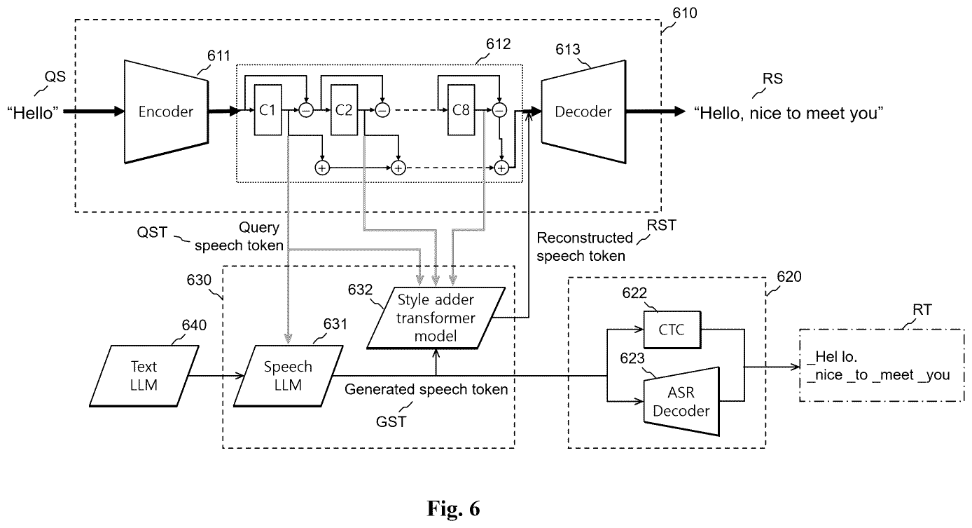

In the system according to an embodiment of the present disclosure, BPE is used as a speech token. The system of FIG. 6 may be constructed by being combined with a speech language generation model 630 based on an autoencoder model 610 that is generated by learning BPE, that is, a speech token. The speech language generation model 630 may include a speech LLM 631 that handles only information of a speech token from the first codebook C1 and a style adder transformer model 632 that sequentially generates all of codebooks. That is, a large language model capable of containing context information by using speech tokens in the BPE unit is generated. Thereafter, in order to play back the context information in the form of a speech again, information on speech styles, such as rhymes, is incorporated. To this end, the style adder transformer model 632 receives a vector string from the first codebook C1 to the last codebook C8 and learns a relation between the codebooks so that the codebook vectors are sequentially generated. In an embodiment, when the speech-based language model 631 generates a codebook string in which only the first codebook vectors are listed, the style adder transformer model 632 may reconstruct all of codebook speech tokens by sequentially generating the remaining codebooks between the first codebook stings. In an embodiment, the speech-based language model 631 and the style adder transformer model 632 may be constructed in a training manner in which models are separately generated and combined or a manner in which models are simultaneously generated. The speech tokens that are reconstructed as described above are transformed into a speech into which styles have been incorporated through a decoder operation of the decoder 613.

The speech-based language model 631 is trained by the speech tokens constructed in the BPE unit. Such a speech token may closely correspond to the BPE unit because the speech token is a token having a machine speech from which the diversity of a speech has disappeared. Accordingly, the speech-based language model 631 can better cooperate with a text language model (LLM) 640 in which a lot of text is used as a token having the BPE unit. This means that the speech-based language model 631 can be well supplemented by using the text LLM 640 that has been generated.

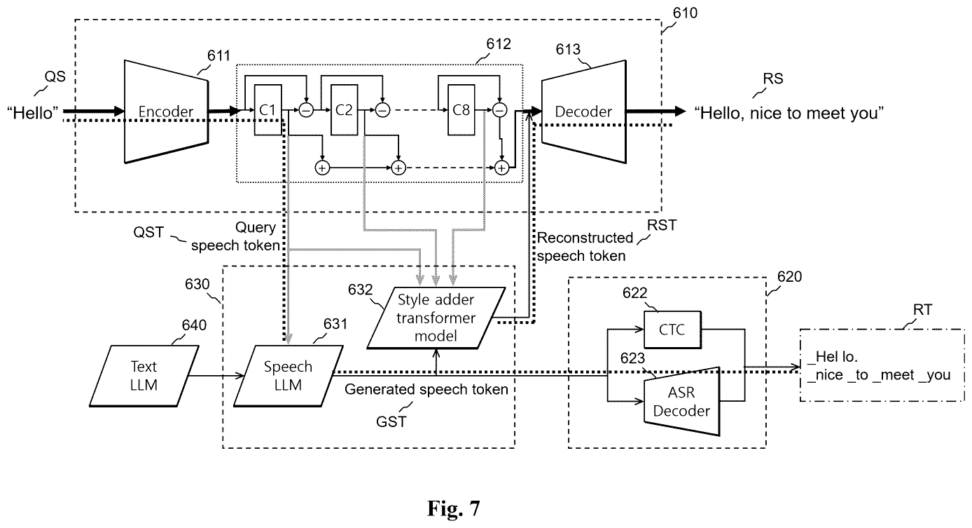

The system of FIG. 6 that has been trained may generate a final answer in accordance with a dotted line with respect to an input speech query QS as illustrated in FIG. 7. For example, when an input “Hello” is received, the input is encoded by an encoder 611, and the first codebook C1 is determined by an autoencoder model 610. A determined speech token string is input to the speech language generation model 630, so that a new speech token string GST is generated through the speech-based language model 631. The style adder transformation model 632 generates a reconstructed speech token string RST by adding the remaining codebook vector of a speech style to the generated speech token string GST. That is, the style adder transformation model 632 may generate and add codebooks having the input speech style with respect to the speech token GST that is received from the speech-based language model 631 by using the remaining codebook vectors selected through the speech that is input to the autoencoder model 610 as a prompt value of a generative model. The speech token RST reconstructed as described above may be transformed into a speech through a decoder 613. For example, a speech response RS “Hello, nice to meet you” may be output with respect to the speech query QS “Hello”. The speech token GST generated by the speech-based language model 631 has been generated based on the BPE unit trained through the speech recognizer 620. Accordingly, the speech token GST may be indicated as text by being transformed into BPE through the speech recognizer CTC 622 and the speech recognizer decoder 623. For example, a text response RT “_Hel lo, _nice _to _meet _you” is output in the BPE unit with respect to the input speech query QS “Hello”. That is, the text response RT has a form in which the text response is made in the form of both a speech and text. Accordingly, upon communication with an artificial intelligence system, a more convenient interface can be provided.

### 4. System Using Sentence Generation Ability of Text Language Model by Being Applied to the Existing Text Language Model

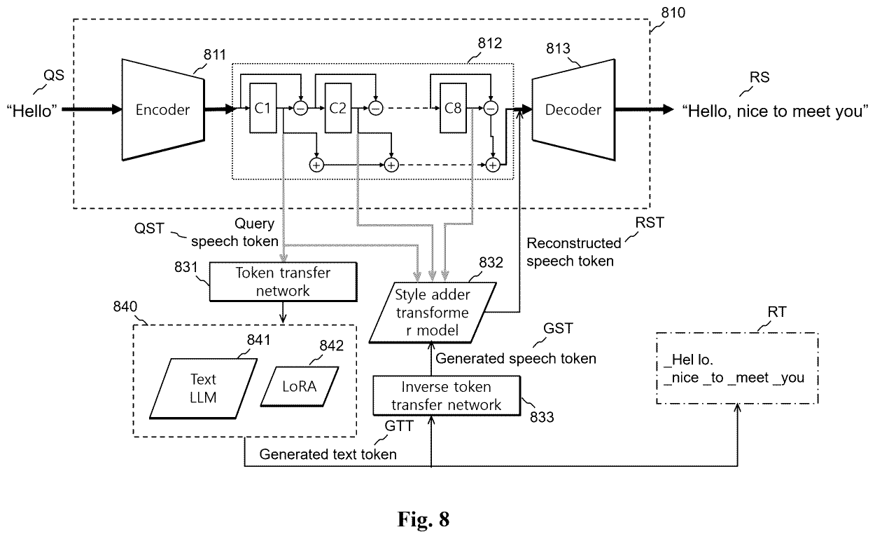

One characteristic of an embodiment of the present disclosure is that a speech token can be easily transformed into a text token because the speech token having the BPE unit is processed. As in the construction diagram of FIG. 8, query speech data QS are transformed into a speech token by an autoencoder or a speech codec 810. A transformed query speech token QST is transformed into a text token through a token transfer network 831, that is, a token transformation model. The token transfer network 831 may transform the query speech token into a specific text token according to a consecutive pattern based on a probability like a CTC network of a speech recognizer. Furthermore, the token transfer network 831 may be generated by applying a distilling scheme for reducing a distance between vectors so that an embedding text vector, that is, an answer transcript for the query speech token QST, and the query speech token QST become similar. The text token transformed as described above is input to an adaptive-trained text model 840. The adaptive-trained text model 840 generates a generated text token GTT, that is, response text for the speech query. The adaptive-trained text model 840 may be obtained by training the existing text-based language model 841 based on additional parameters by using a method, such as low rank adaptation (LoRA), for example. If such an adaptive-trained text model 840 is used, text LLM having an excellent information-based sentence generation ability compared to a speech LLM can be used.

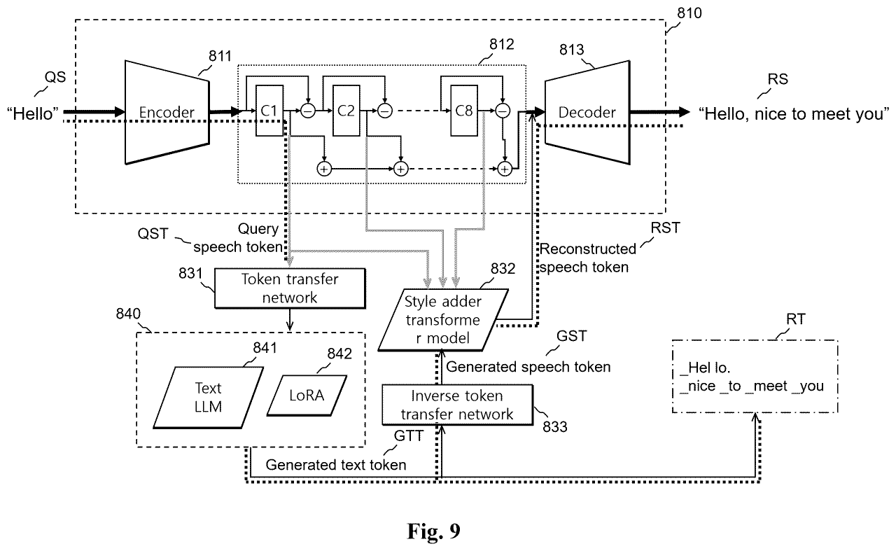

The text token GTT generated by the adaptive-trained text model 840 is transformed into a speech token GST that is closest to the text token GTT in probability by an inverse token transfer network, that is, a token transformation model. A style adder transformation model 832 outputs a reconstructed speech token RST that enables a speech, such as the speech style of a speaker that is received from the speechcodec 810, to be generated by transforming the speech token GST by modeling information on the speech style of the speaker. The reconstructed speech token RST is transformed into the speech by the decoder 813, and thus a speech response RS is output. Furthermore, the text token GTT generated by the adaptive-trained text model 840 is output as the text response RTS. Through such a process, a speech response into which the text response and the speech style of the speaker have been incorporated may be output by using the sentence generation ability of the text language model 840 obtained by finely adjusting the existing text language model. In the system of FIG. 8, a path along which the speech query is processed is indicated by a dotted line in FIG. 9.

The system of FIG. 8 uses the sentence generation ability of a large text language model in a speech language model in a way to fix and adapt the existing text language model. Through such a construction, a speech LLM constructed to increase the naturality of a dialogue based on the existing various types of speech information of speakers, such as rhymes, tones, and styles, can solve a problem in that the information-based sentence generation ability is greatly reduced in the text LLM.

The method according to an embodiment of the present disclosure may be implemented in the form of a program instruction which may be executed through various computer means, and may be recorded on a computer-readable medium.

The computer-readable medium may include program instructions, data files, and data structure alone or in combination. A program instruction recorded on the computer-readable medium may be specially designed and constructed for an embodiment of the present disclosure or may be known and available to those skilled in the computer software field. The computer-readable medium may include a hardware device configured to store and execute the program instruction. For example, the computer-readable medium may include magnetic media such as a hard disk, a floppy disk, and a magnetic tape, optical media such as CD-ROM and a DVD, magneto-optical media such as a floptical disk, ROM, RAM, and flash memory. The program instruction may include not only a machine code produced by a compiler, but a high-level language code capable of being executed by a computer through an interpreter.

The embodiments of the present disclosure have been described in detail, but the scope of rights of the present disclosure is not limited thereto. A variety of modifications and changes made by those skilled in the art using the basic concept of the present disclosure defined in the appended claims are also included in the scope of rights of the present disclosure.

### DESCRIPTION OF REFERENCE NUMERALS

110: autoencoder, 111: encoder, 112: vector quantizer, 113: decoder, 114: discriminator, 120: speech recognizer, 121: speech recognizer encoder, 122: speech recognizer CTC, 123: speech recognizer decoder, 130: speech LLM, 610: autoencoder, 620: speech recognizer, 630: speech language generation model, 810: autoencoder, 831: token transfer network, 832: style adder transformation model, 833: inverse token transfer network, 840: adaptive-trained text model.

What is claimed is:

1. A method of generating speech tokens capable of being easily transformed into text tokens, the method comprising steps of:
training an autoencoder by using a speech recognizer that comprises a speech recognizer encoder, a CTC module, and a speech recognizer decoder and that is trained by byte pair encoding (BPE), the autoencoder comprising an encoder configured to down-sample input speech data while transforming and compressing the input speech data into a vector, a vector quantizer configured to quantize data that have experienced the encoder into a plurality of codebooks, and a decoder configured to reconstruct quantized codebook vectors as an original speech by combining the quantized codebook vectors; and
generating an output of a first codebook of the autoencoder that is trained as a speech token for a speech that is input to the autoencoder.

2. The method of claim 1, wherein in the training step, a vector distance is used as a loss, the vector distance being calculated through steps of generating a first codebook vector of the input speech data through the vector quantizer of the autoencoder, performing a forward operation on the input speech data through the speech recognizer encoder, and performing a vector distance operation between a vector on which the execution of the forward operation has been finished and a first codebook vector.

3. The method of claim 1, wherein in the training step, a difference between a first probability distribution and a second distribution is used as a loss, the first probability distribution and the second distribution being calculated through steps of generating a first codebook vector of the input speech data through the vector quantizer of the autoencoder, calculating a vector that has experienced the speech recognizer encoder by performing a forward operation on the input speech data through the speech recognizer encoder, and measuring the first probability distribution of a vector that has experienced the speech recognizer encoder in speech recognizer CTC and the second probability distribution that has experienced the speech recognizer CTC as the first codebook vector.

4. The method of claim 1, wherein in the training step, a difference between a first probability distribution and a second probability distribution is used as a loss, the first probability distribution and the second distribution being calculated through steps of generating a first codebook vector of the input speech data through the vector quantizer of the autoencoder, calculating a vector that has experienced the speech recognizer encoder by performing a forward operation on the input speech data through the speech recognizer encoder, and measuring the first probability distribution of a vector that has experienced the speech recognizer encoder in the speech recognizer decoder and the second probability distribution that has experienced the speech recognizer decoder as the first codebook vector.

5. The method of claim 1, wherein the training step comprises generating a codebook so that the codebook learns components of a style of the speech by performing a residual vector quantization operation except a first codebook vector, among encoder output vectors of the autoencoder.

6. The method of claim 5, wherein the training step comprises steps of:
generating speech data by performing the forward operation on a sum vector of all of the codebooks through the decoder,
measuring an adversarial loss of the generated speech data through a discriminator operation of determining a similar degree with respect to a time domain and a frequency domain with the input speech data, and
performing inverse propagation on the plurality of measured losses through a differential operation and updating parameters of a model.

7. The method of claim 6, wherein the training step is repeated by a predetermined training number or until a predetermined threshold of each of the losses is reached.

8. A spoken language model system comprising:
an autoencoder model comprising an encoder configured to down-sample input speech data while transforming and compressing the input speech data into a vector, a vector quantizer configured to quantize data that have experienced the encoder into a plurality of codebooks, and a decoder configured to reconstruct quantized codebook vectors as an original speech by combining the quantized codebook vectors, the autoencoder model being trained by using a speech recognizer that comprises a speech recognizer encoder, a CTC module, and a speech recognizer decoder and that is trained by byte pair encoding (BPE), and the autoencoder model being configured to output an output of a first codebook as a query speech token of input query speech data; and
a speech language generation model comprising a speech-based language model configured to generate a speech token as a response to the query speech token and a style adder transformation model configured to generate a reconstructed speech token by using a vector string from at least some of the plurality of codebooks with respect to the generated speech token,
wherein the reconstructed speech token is output through the decoder of the autoencoder model.

9. The spoken language model system of claim 8, further comprising a speech recognizer configured to transform the generated speech token into text.

10. The spoken language model system of claim 9, wherein the autoencoder model is trained by using a vector distance as a loss, the vector distance being calculated through steps of generating a first codebook vector of the input speech data through the vector quantizer of the autoencoder, performing a forward operation on the input speech data through the speech recognizer encoder, and performing a vector distance operation between a vector on which the execution of the forward operation has been finished and a first codebook vector.

11. The spoken language model system of claim 9, wherein the autoencoder model is trained by using a difference between a first probability distribution and a second probability distribution as a loss, the first probability distribution and the second distribution being calculated through steps of generating a first codebook vector of the input speech data through the vector quantizer of the autoencoder, calculating a vector that has experienced the speech recognizer encoder by performing a forward operation on the input speech data through the speech recognizer encoder, and measuring the first probability distribution of a vector that has experienced the speech recognizer encoder in speech recognizer CTC and the second probability distribution that has experienced the speech recognizer CTC as the first codebook vector.

12. The spoken language model system of claim 9, wherein the autoencoder model is trained by using a difference between a first probability distribution and a second probability distribution as a loss, the first probability distribution and the second distribution being calculated through steps of generating a first codebook vector of the input speech data through the vector quantizer of the autoencoder, calculating a vector that has experienced the speech recognizer encoder by performing a forward operation on the input speech data through the speech recognizer encoder, and measuring the first probability distribution of a vector that has experienced the speech recognizer encoder in the speech recognizer decoder and the second probability distribution that has experienced the speech recognizer decoder as the first codebook vector.

13. The spoken language model system of claim 9, wherein the autoencoder model is trained through steps of:
generating a codebook so that the autoencoder model learns components of a style of the speech by performing a residual vector quantization operation except a first codebook vector, among encoder output vectors of the autoencoder;
generating the speech data by performing a forward operation on a sum vector of all of the codebooks through the decoder;
measuring an adversarial loss of the generated speech data through a discriminator operation of determining a similar degree with respect to a time domain and a frequency domain with the input speech data; and
performing inverse propagation on a plurality of measured losses through a differential operation and updating parameters of the autoencoder model.

14. A spoken language model system comprising:
an autoencoder model comprising an encoder configured to down-sample input speech data while transforming and compressing the input speech data into a vector, a vector quantizer configured to quantize data that have experienced the encoder into a plurality of codebooks, and a decoder configured to reconstruct quantized codebook vectors as an original speech by combining the quantized codebook vectors, the autoencoder model being trained by using a speech recognizer that comprises a speech recognizer encoder, a CTC module, and a speech recognizer decoder and that is trained by byte pair encoding (BPE), and the autoencoder model being configured to output an output of a first codebook as a query speech token of input query speech data;
a token transfer network configured to transform the query speech token into a text token by distilling the query speech token as embedding text;
an adaptive-trained text model configured to generate a text token as a response to the text token;
an inverse token transfer network configured to transform the generated text token into a generated speech token; and
a style adder transformation model configured to generate a reconstructed speech token by using a vector string from at least some of the plurality of codebooks with respect to the generated speech token,
wherein the reconstructed speech token is output through the decoder of the autoencoder model.

15. The spoken language model system of claim 14, wherein the autoencoder model is trained by using a vector distance as a loss, which is calculated through steps of generating a first codebook vector of the input speech data through the vector quantizer of the autoencoder, performing a forward operation on the input speech data through the speech recognizer encoder, and performing a vector distance operation between a vector on which the execution of the forward operation has been finished and a first codebook vector.

16. The spoken language model system of claim 14, wherein the autoencoder model is trained by using a difference between a first probability distribution and a second probability distribution as a loss, the first probability distribution and the second distribution being calculated through steps of generating a first codebook vector of the input speech data through the vector quantizer of the autoencoder, calculating a vector that has experienced the speech recognizer encoder by performing a forward operation on the input speech data through the speech recognizer encoder, and measuring the first probability distribution of a vector that has experienced the speech recognizer encoder in speech recognizer CTC and the second probability distribution that has experienced the speech recognizer CTC as the first codebook vector.

17. The spoken language model system of claim 14, wherein the autoencoder model is trained by using a difference between a first probability distribution and a second probability distribution as a loss, the first probability distribution and the second distribution being calculated through steps of generating a first codebook vector of the input speech data through the vector quantizer of the autoencoder, calculating a vector that has experienced the speech recognizer encoder by performing a forward operation on the input speech data through the speech recognizer encoder, and measuring the first probability distribution of a vector that has experienced the speech recognizer encoder in the speech recognizer decoder and the second probability distribution that has experienced the speech recognizer decoder as the first codebook vector.

18. The spoken language model system of claim 14, wherein the autoencoder model is trained through steps of:
generating a codebook so that the autoencoder model learns components of a style of a speech by performing a residual vector quantization operation except a first codebook vector, among encoder output vectors of the autoencoder;
generating the speech data by performing a forward operation on a sum vector of all of the codebooks through the decoder;
measuring an adversarial loss of the generated speech data through a discriminator operation of determining a similar degree with respect to a time domain and a frequency domain with the input speech data; and
performing inverse propagation on a plurality of measured losses through a differential operation and updating parameters of the autoencoder model.

19. The spoken language model system of claim 14, wherein the adaptive-trained text model is obtained by training a text-based language model by using an additional parameter according to a low rank adaptation (LoRA) method.

20. The spoken language model system of claim 14, wherein:
the token transfer network transforms the speech token into a text token according to a consecutive pattern based on a probability, and
the inverse token transfer network outputs the speech token that is closest to an input text token in probability.
